(19) United States
(12) Patent Application Publication
(10) Pub. No.: US 2011/0242028 A1
(43) Pub. Date: Oct. 6, 2011

(54) METHOD AND APPARATUS FOR FORMING ELECTRODE PATTERN ON TOUCH PANEL

(76) Inventors: Chang-ju Lee, Suwon-si (KR); Kyung-myun Kim, Seongnam-si (KR); Yoon-kyung Chol, Yongin-si (KR)

(21) Appl. No.: 13/074,042

(22) Filed: Mar. 29, 2011

(30) Foreign Application Priority Data
Apr. 2, 2010 (KR) 10-2010-0030628

(51) Int. Cl. G06F 3/041

(52) U.S. Cl. 345/173

(57) ABSTRACT

A touch sense panel includes a first set of individual sensing units for sensing a location along a first axis. The first set of individual sensing units includes a first plurality of strings of individual sensing units, each string including at least two of the individual sensing units of the first set. The at least two individual sensing units are electrically connected to each other and arranged in a direction perpendicular to the first axis. A first individual sensing unit of a first string of the first plurality of strings is electrically connected to a first individual sensing unit of a second string of the first plurality of strings, the second string adjacent to the first string, such that the first string and the second string form a single, first electrode.

### CROSS-REFERENCE TO RELATED APPLICATIONS

This application claims the benefit of Korean Patent Application No. 10-2010-0030628, filed on Apr. 2, 2010, in the Korean Intellectual Property Office, the disclosure of which is incorporated herein in its entirety by reference.

### BACKGROUND

The inventive concept relates to improvement of the accuracy of a touch sense panel, and more particularly, to a method of improving the accuracy of a touch sense panel in a display device or system and a touch system with improved sensing accuracy.

Recently, portable electronic devices have become smaller and thinner to meet user demand. Touch screens that do not include unnecessary buttons and that have an appealing design are widely used in general automated teller machines (ATMs), televisions (TVs), and general home appliances as well as small-sized electronic devices. Particularly, mobile phones, portable multimedia players (PMPs), personal digital assistants (PDAs), e-books, and the like, which require miniaturization, have become smaller for easy carrying. In order to realize miniaturization of portable devices, a method of unifying an input button with a screen has been in the spotlight. For the method of unifying an input button with a screen, touch recognition technology for a touch screen that recognizes a touch on a touch panel and acts as an interface is emerging as significant technology.

In general, a touch screen is an input device that constitutes an interface between a user and an information communication device using any of various displays. The user directly contacts the touch screen by using his/her finger or an input tool such as a stylus pen, and thus men and women of all ages may easily use the information communication device. Examples of flat panel display devices including a touch screen include liquid crystal display (LCD) devices, field emission display (FED) devices, organic light-emitting display (OLED) devices, and plasma display panel (PDP) devices.

Flat panel display devices generally include a plurality of pixels arranged in the form of a matrix so as to display images. For example, LCD devices may include a plurality of scan lines for transmitting gate signals and a plurality of data lines for transmitting gray scale data. The plurality of pixels are formed at points at which the plurality of scan lines and the plurality of data lines cross one another. Each of the pixels may include a transistor and a capacitor, or only a capacitor.

A touch screen may use any of various methods such as a resistive overlay method, a capacitive overlay method, a surface acoustic wave method, an infrared method, a surface elastic wave method, and an inductive method.

When a touch screen uses a resistive overlay method, a resistive material is coated on a glass or transparent plastic plate, a polyester film is covered thereon, and insulating rods are installed at regular intervals so that two sides of the polyester film do not contact each other. In this case, a resistance and a voltage are varied. The location of a finger contacting the touch screen is recognized by using a change in the voltage. The touch screen using the resistive overlay method has an advantage in that an input may be made in cursive script, but has disadvantages in that transmittance and durability are low and multi-point sensing is typically impossible.

When a touch screen uses a surface acoustic wave method, a transmitter for emitting sound waves and a reflector for reflecting the sound waves at regular intervals are attached to a surface glass, and a receiver is attached to a surface opposite to the side of the glass on which the transmitter and the reflector are attached. A time at which an object, such as a finger, interrupts a proceeding path of sound waves is used to recognize a touch point.

When a touch screen uses an infrared method, the linearity of infrared rays, which are not visible, is used. A matrix is formed by disposing an infrared light-emitting diode (LED) as a light-emitting device and a phototransistor as a light receiving device to face each other. Interception of light by an object, such as a finger, in the matrix is detected to recognize a touch point.

At present, many portable electronic devices use a resistive overlay method, which is relatively inexpensive and allows various input tools, such as a hand, a pen, or the like, to be used. However, as research into user interfaces using a multi-touch has been actively conducted, a touch screen using a capacitive overlay method, by which multi-touch recognition may be performed, has become more prevalent. Examples of capacitive-type touch screens are described in U.S. Patent Application Publication Nos. 2010/0156795 and 2007/0273560, both of which are incorporated herein by reference in their entirety.

It is important in using a touch screen as an interface for a touch point touched by a user to be recognized by information communication equipment, and for an accurate coordinate to be displayed on a display device.

### SUMMARY

The inventive concept provides a touch panel device and a method of forming a touch panel pattern that, when a touch screen is used as an interface of information communication equipment, may recognize a touch point touched by a user and display an accurate coordinate on a display device.

According to an aspect of the inventive concept, there is provided a touch sense panel including a first set of individual sensing units for sensing a location along a first axis. The first set of individual sensing units includes a first plurality of strings of individual sensing units, each string including at least two of the individual sensing units of the first set. The at least two individual sensing units are electrically connected to each other and arranged in a direction perpendicular to the first axis. A first individual sensing unit of a first string of the first plurality of strings is electrically connected to a first individual sensing unit of a second string of the first plurality of strings, the second string adjacent to the first string, such that the first string and the second string form a single, first electrode.

The first sensing unit of the first string and the first sensing unit of the second string may be arranged adjacent to each other in a direction parallel to the first axis.

A second sensing unit of the first string may be electrically connected to a second sensing unit of the second string.

The first electrode may be connected to a touch controller through a connection line.

The first set of individual sensing units may include individual first electrodes having a diamond shape, such that at least one corner of each individual first electrode is adjacent a corner of another one of the individual first electrodes.

In one embodiment, the touch sense panel further includes a second set of individual sensing units for sensing a location along a second axis, the second set of individual sensing units interleaved with the first set of individual sensing units. The second set of individual sensing units may include a plurality of second strings of individual sensing units, each string including at least two of the individual sensing units of the second set, the at least two individual sensing units electrically connected to each other and arranged in a direction perpendicular to the second axis. A first individual sensing unit of a first string of the plurality of second strings is electrically connected to a first individual sensing unit of a second string of the plurality of second strings, the second string adjacent to the first string, such that the first string and the second string form a single, second electrode. The first electrode may be connected to a touch controller through a first connection line, and the second electrode may be connected to the touch controller through a second connection line. The first axis may be perpendicular to the second axis. In a further embodiment, the first set of individual sensing units includes individual first electrodes having a diamond shape, such that at least one corner of each individual first electrode is adjacent a corner of another one of the individual first electrodes; the second set of individual sensing units includes individual second electrodes having a diamond shape, such that at least one corner of each individual second electrode is adjacent a corner of another one of the individual second electrodes, and at least one side of each individual first electrode is adjacent a side of an individual second electrode.

In a further embodiment, the touch sense panel is connected to a controller and is overlaid on a display panel.

According to another aspect of the inventive concept, a touch sense panel is disclosed. The touch sense panel includes a first set of individual sensing units for sensing a location along a first axis. The first set of individual sensing units comprise a first electrode including at least two of the individual sensing units of the first set arranged in a direction perpendicular to the first axis, and a second electrode including at least two other of the individual sensing units of the first set arranged in a direction perpendicular to the first axis. The first electrode and the second electrode are electrically connected to each other to form a first common electrode.

In one embodiment, the touch sense panel further includes a second set of individual sensing units for sensing a location along a second axis. The second set of individual sensing units are interleaved with the first set, and comprise a third electrode including at least two of the individual sensing units of the second set arranged in a direction perpendicular to the second axis, and a fourth electrode including at least two other of the individual sensing units of the second set arranged in a direction perpendicular to the second axis. The third electrode and the fourth electrode are electrically connected to each other to form a second common electrode. The first axis may be perpendicular to the second axis. The first common electrode may be connected to a touch controller through a first connection line, and the second common electrode may be connected to the touch controller through a second connection line. The first set of individual sensing units may include individual first electrodes having a diamond shape, such that at least one corner of each individual first electrode is adjacent a corner of another one of the individual first electrodes. The second set of individual sensing units may include individual second electrodes having a diamond shape, such that at least one corner of each individual second electrode is adjacent a corner of another one of the individual second electrodes. At least one side of each individual first electrode may be adjacent a side of an individual second electrode.

In one embodiment, the touch sense panel may be connected to a controller and may be overlaid on a display panel. The touch sense panel may be part of a cell phone, PDA, a television, a portable multimedia player, an e-book, or a navigation device.

In another embodiment, a device including a touch sense panel is disclosed. The device comprises a touch sense panel including a plurality of rows and columns, each row including a string of individual electrodes, and each column including a string of individual electrodes. Each row is electrically connected to at least one other row to form a common electrode, and each column is electrically connected to at least one other column to form a common electrode. The device further comprises a plurality of connection lines. Each connection line is connected to a respective common electrode, so that the number of common electrodes is at least two times the number of lines in the plurality of connection.

In a further embodiment, the device includes a display panel over which the touch sense panel is overlaid. In another embodiment the plurality of individual electrodes in the columns are not electrically connected to the plurality of individual electrodes in the rows.

### BRIEF DESCRIPTION OF THE DRAWINGS

Exemplary embodiments of the inventive concept will be more clearly understood from the following detailed description taken in conjunction with the accompanying drawings in which:

FIG. 1 illustrates an exemplary touch sense panel using a capacitive overlay method, according to certain disclosed embodiments;

FIG. 2 illustrates an exemplary case where a touch is sensed when a touch panel using a mutual capacitive method is used, according to certain disclosed embodiments;

FIGS. 3A and 3B illustrate exemplary touch sense panels using a capacitive overlay method, according to certain disclosed embodiments;

FIGS. 4A and 4B illustrate exemplary cases where a conductive rod touches sensing units of different sizes, according to certain disclosed embodiments;

FIG. 5A illustrates an exemplary case where a conductive rod is moved on a touch sense panel using a capacitive overlay method, according to certain disclosed embodiments;

FIG. 5B illustrates an exemplary case where a conductive rod is moved on a touch sense panel using a capacitive overlay method according to certain disclosed embodiments;

FIGS. 5C and 5D illustrate cases where a conductive rod is moved on touch sense panels using a capacitive overlay method, according to certain disclosed embodiments;

FIG. 6A illustrates an exemplary electrode connection line of a touch sense panel using a capacitive overlay method, according to certain disclosed embodiments;

FIG. 6B illustrates an exemplary electrode unit cell of the touch sense panel of FIG. 6A, according to certain disclosed embodiments;

FIG. 7A illustrates an exemplary case where sensing units are connected as two pairs in a touch sense panel using a capacitive overlay method according to certain disclosed embodiments;

FIG. 7B illustrates an exemplary electrode unit cell of the touch sense panel of FIG. 7A, according to certain disclosed embodiments;

FIG. 7C illustrates an exemplary case where sensing units are connected as three pairs in a touch sense panel using a capacitive overlay method according to certain disclosed embodiments;

FIG. 7D illustrates an exemplary electrode unit cell of the touch sense panel of FIG. 7B, according to certain disclosed embodiments;

FIGS. 8A and 8B are exemplary simulation graphs illustrating accuracy between a touch point and a touch coordinate according to electrode patterns in touch sense panels using a capacitive overlay method, according to certain disclosed embodiments;

FIG. 9 is an exemplary flowchart illustrating a method of forming a touch panel on which two or more electrodes are connected, according to certain disclosed embodiments;

FIGS. 10A, 10B, 10C, and 10D illustrate exemplary structures of a printed circuit board (PCB) of a display device on which a touch panel is mounted, according to certain disclosed embodiments;

FIGS. 11A, 11B, 11C, and 11D illustrate exemplary structures of a PCB when a touch panel and a display panel are incorporated, according to certain disclosed embodiments; and

FIG. 12 illustrates various exemplary products in which a touch panel according to certain disclosed embodiments is installed.

### DETAILED DESCRIPTION

Since a structural or functional description is provided to describe exemplary embodiments of the inventive concept, the inventive concept may be embodied in many different forms and should not be construed as being limited to the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the inventive concept.

It will be understood that when an element or layer is referred to as being “formed on,” another element or layer, it can be directly or indirectly formed on the other element or layer. That is, for example, intervening elements or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Like reference numerals denote like elements in the drawings.

The inventive concept will now be described more fully with reference to the accompanying drawings, in which exemplary embodiments of the inventive concept are shown. A touch screen panel, a touch sense panel, a touch sensing panel, a touch panel, and the like may be used interchangeably throughout this paper.

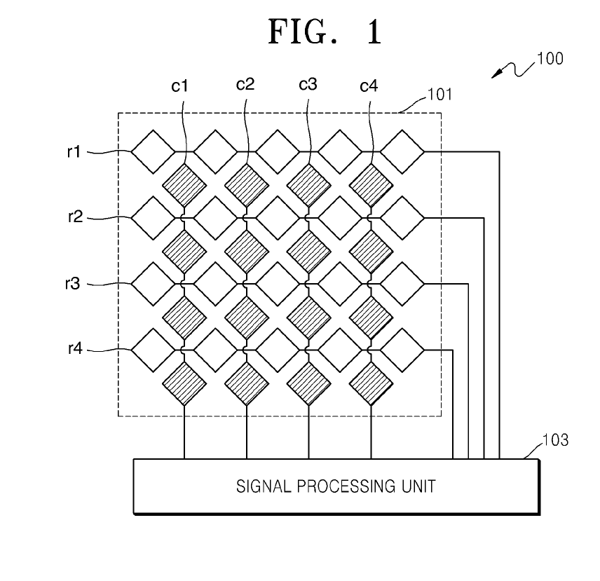

FIG. 1 illustrates an exemplary touch screen panel 101 and a signal processing unit 103 for processing a touch signal. Referring to FIG. 1, a touch screen system 100 includes the touch screen panel 101 including a plurality of sensing units, and the signal processing unit 103 for sensing a change in a capacitance of each of the sensing units of the touch screen panel 101 and processing the change to generate touch data. The term “sensing unit” as used herein may refer to an individual sensing unit (such as one of the diamond-shape units shown in FIG. 1) or to a group of individual sensing units (such as a string of individual sensing units).

The touch screen panel 101 includes a plurality of the sensing units arranged along a first axis and a plurality of the sensing units arranged along a second axis. The first axis and second axis may be perpendicular such that the sensing units form rows and columns. The rows and the columns are relative, and as such the terms may be used interchangeably. As an example, as shown in FIG. 1, the touch screen panel 101 includes a plurality of rows r1-r4, and a plurality of the individual sensing units are disposed in each of the rows to form a string of individual sensing units. Each of the individual sensing units may include an individual electrode. The sensing units disposed in each of the rows may be electrically connected to one another, thereby forming an electrode formed of a plurality of individual electrodes. Also, the touch screen panel 101 includes a plurality of columns c1-c4, and a plurality of the individual sensing units are disposed in each of the columns to form a string of individual sensing units. Each of the individual sensing units may include an individual electrode. The sensing units disposed in each of the columns may be electrically connected to one another, thereby forming an electrode formed of a plurality of individual electrodes.

The signal processing unit 103 senses a change in the capacitance of each of the sensing units of the touch screen panel 101 and generates touch data. For example, by sensing a change in the capacitance of each of the individual sensing units in the plurality of rows and in the plurality of columns, the signal processing unit 103 determines whether a user's finger or a touch pen (e.g., a stylus pen) touches the touch screen panel 210 and determines a touch point.

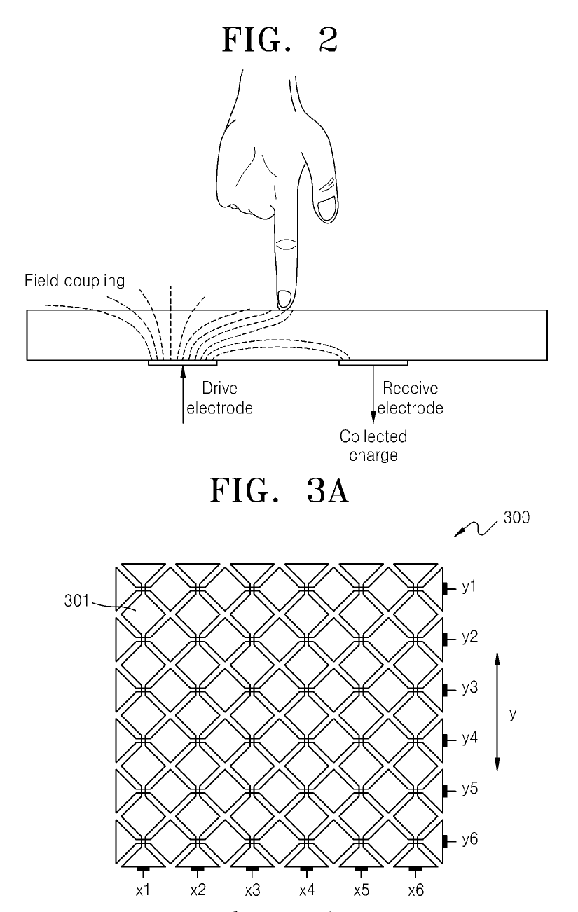

FIG. 2 illustrates an exemplary case where a touch is sensed when a touch panel using a mutual capacitive method is used.

Referring to FIG. 2, in the mutual capacitive method, a predetermined voltage pulse is applied to a drive electrode and charges corresponding to the voltage pulse are collected in a receive electrode. If a person's finger is put between the drive electrode and the receive electrodes, an electric field, marked by dotted lines, is changed.

A system using such a touch panel senses a touch when a capacitance between two electrodes is changed due to a change in an electric field between the two electrodes. Although the mutual capacitive method is used in FIG. 2, the inventive concept may also be applied to a self-capacitance method, and a better effect may be obtained from the self-capacitance method.

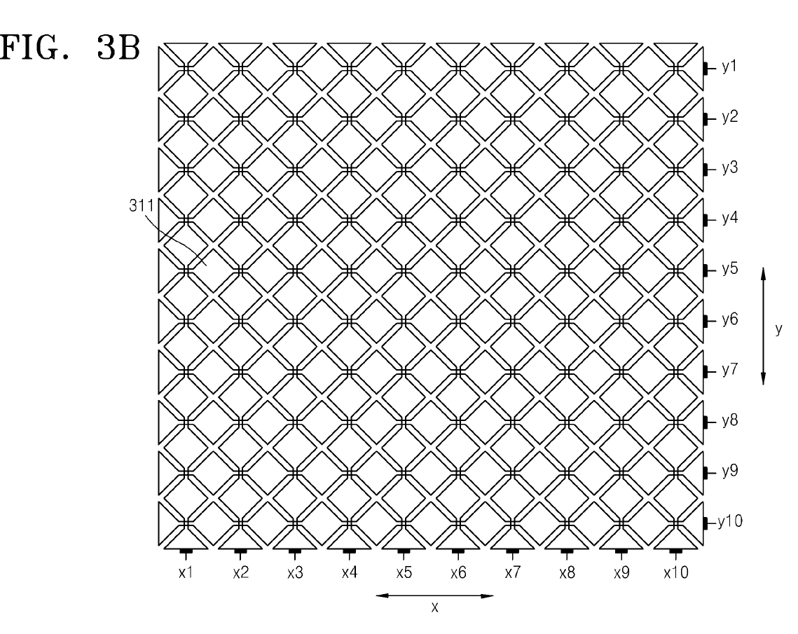

FIGS. 3A and 3B illustrate an exemplary touch sense panel 300 using a capacitive overlay method.

Referring to FIGS. 3A and 3B, the touch screen panel 300 includes a plurality of sensing units 301 densely arranged in rows and columns to sense a touch point in an x-y coordinate system. In FIG. 3A schematically illustrating the touch screen panel 300, sensing units x1 through x6 are arranged to form columns perpendicular to the x-axis direction, and sensing units y1 through y6 are arranged to form rows perpendicular to the y-axis direction. Each of sensing units x1 through x6 and y1 through y6 may include a string of individual sensing units that are electrically connected to form one electrode. When an object, such as a finger or a pen, approaches or touches any of the individual sensing units 301, which are also called pixels, a capacitance for that pixel, and thus for a group of pixels electrically connected to that pixel, is changed, and thus a touch coordinate is calculated by sensing a change in the capacitance.

However, in order to display an accurate coordinate of a location touched by a small touch point of an object, e.g., a stylus pen, placed or dragged on a display device, smaller pixels need to be arranged on the same area.

FIG. 3B illustrates an example where individual sensing units 311 have the same shapes as the sensing units 301 of FIG. 3A but are smaller in order to dispose more sensing units on the same area. Sensing units x1 through x10 are disposed to form columns perpendicular to the x-axis direction and sensing units y1 through y10 are disposed to form rows perpendicular to y-axis direction on a panel. The individual sensing units 311 of FIG. 3B may display a more accurate coordinate than the individual sensing units 301 of FIG. 3A. However, since sizes (areas) of the sensing units 311 are less than those of the sensing units 301 of FIG. 3A, the amount of sensing energy of each sensing unit 311 is reduced compared to that of each sensing unit 301, thereby making it more difficult to distinguish a touch from a non-touch. Also, the sensing units 311 of FIG. 3B are more vulnerable to noise. Also, since the number of x electrode channels and the number of y electrode channels are greater in FIG. 3B than those of FIG. 3A, the number of connection lines connected to the signal processing unit 103 in FIG. 3B is greater than that in FIG. 3A, and thus an area occupied by a connection line pattern in FIG. 3B is greater than that in FIG. 3A. As an area occupied by a connection line pattern is increased, a dead zone of a display panel, in which the connection line pattern is disposed and in which a touch may not be sensed, coupled to a touch sense panel is increased, thereby lowering a space utilization efficiency of a terminal employing the touch sense panel.

The arrangement of sensing units constituting sensing electrodes in a touch system using a capacitive overlay method affects various standards related to touch evaluation. That is, sensing units on a touch panel for recognizing a touch and sizes and shapes of sensing electrodes formed with the sensing units are important factors in determining the performance of a touch system.

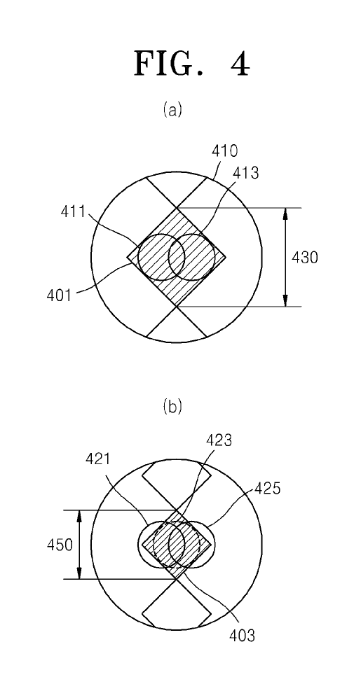

FIGS. 4A and 4B illustrate exemplary cases where a conductive rod touches sensing units of different sizes.

As described above with reference to FIGS. 3A and 3B, when sensing units have the same shape but different sizes, the smaller sensing units have a higher probability of recognizing a more accurate coordinate but the amount of sensing energy of each smaller sensing unit is reduced compared to that of each larger sensing unit, which will be explained in detail with reference to FIGS. 4A and 4B.

Referring to FIG. 4A, an area contacted by a tip of a conductive rod is located within one sensing unit 401. The conductive rod may be, for example, a stylus pen. If the conductive rod is a person's finger tip, the area contacted by the conductive rod may be increased.

In FIG. 4A, a change in an electrostatic capacitance of the sensing unit 401 when the conductive rod touches the sensing unit 401 may be greater than a change in an electrostatic capacitance of any adjacent sensing unit. In FIG. 4B, likewise, a center of a portion touched by the conductive rod is located within a sensing unit 403. Although a change in an electrostatic capacitance (a touch recognition signal) of the sensing unit 403 may be greater than a change in an electrostatic capacitance of an adjacent sensing unit, since the sensing unit 401 is larger than the sensing unit 403, the amount of touch energy may be greater in the sensing unit 401 than in the sensing unit 403 when the conductive rod touches the same sized area on both the sensing units 401 and 403.

Also, a signal-to-noise ratio (SNR) of the sensing unit 401 is greater than an SNR of the sensing unit 403. In this regard, although it is preferable that a sensing unit is large, if a diameter of the conductive rod is smaller than a pitch 430 of the sensing unit 401, that is, if the conductive rod in FIG. 4A is contacting an area included in the sensing unit 401, even when the conductive rod is moved from a position 411 to a position 413, the conductive rod is still contacting an area included in the sensing unit 401, and thus a coordinate displayed is not changed even when the conductive rod is moved, thereby causing an error.

On the other hand, with respect to the sensing unit 401 shown in FIG. 4B, which is relatively small, if the conductive rod is at an initial position 421, a display coordinate corresponds to the left of a center of the sensing unit 403 since the conductive rod contacts a portion beyond the sensing unit 403. If the conductive rod is at a position 423, a display coordinate corresponds to the center of the sensing unit 403 since the conductive rod is contacting an area within the sensing unit 403. If the conductive rod is moved to a position 425, a display coordinate corresponds to the right of the center of the sensing unit 403 since the conductive rod contacts a portion beyond the sensing unit 403. Accordingly, a difference between a touched point and a coordinate displayed on a display in FIG. 4B is less than that in FIG. 4A.

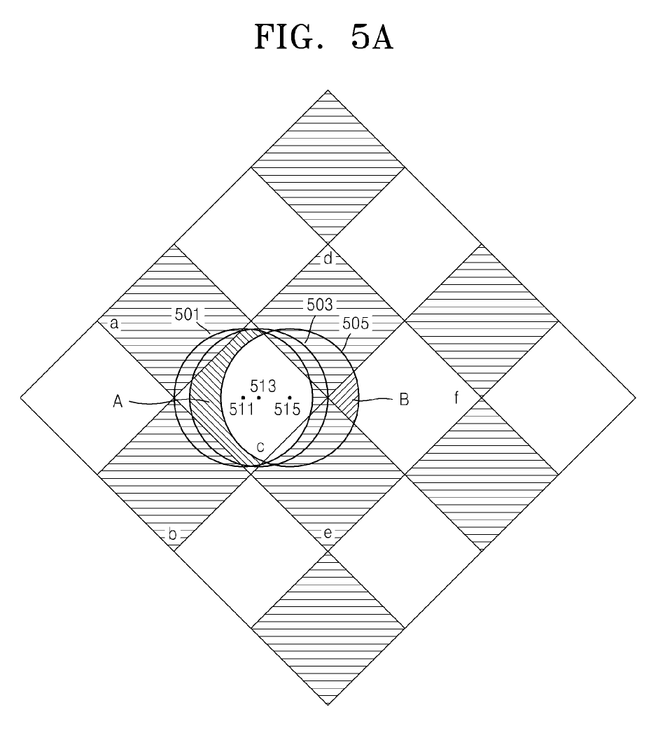

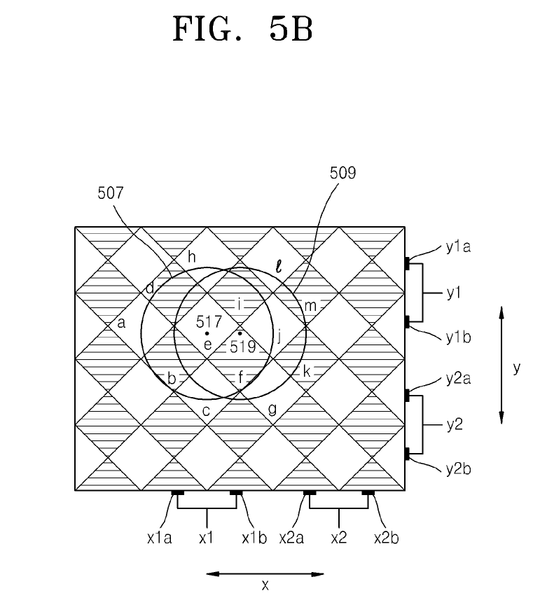

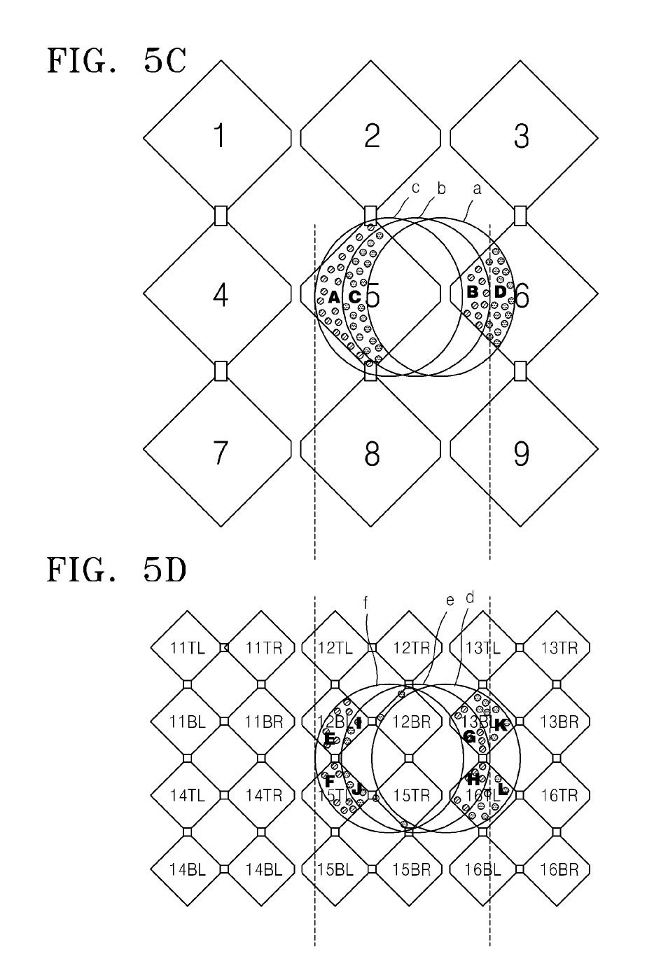

FIG. 5A illustrates an exemplary case where a conductive rod is moved on a touch sense panel using a capacitive overlay method.

It is assumed that the conductive rod is moved from a position 501 to a position 503 to a position 505. A center of an area contacted by the conductive rod is moved from a point 511 to a point 513 to a point 515. For convenience of explanation, it is assumed that the conductive rod is moved only in an x-axis direction (unmarked). First, at the position 501, most of an area contacted by the conductive rod is located within a sensing unit c. That is, a position of the conductive rod in the x-axis direction is determined by only the sensing unit c. Sensing units a, b, d, and e are all sensing units for displaying a position of the conductive rod in a y-axis direction (unmarked) and thus do not contribute to determining of the position of the conductive rod in the x-axis direction.

If the conductive rod is moved to the position 503, the center of the area contacted by the conductive rod is changed from the point 511 to the point 513. However, since the area of the sensing unit c contacted by the conductive rod, which determines the position in the x-axis direction, when the conductive rod is at the position 501 is approximately the same size as the area of the sensing unit c contacted by the conductive rod when the conductive rod is at the position 503, the position of the conductive rod in the x-axis direction displayed on a screen is not changed. Accordingly, there is a difference between a touch point and a coordinate displayed on the screen.

Now, the conductive rod is moved from the position 503 to the position 505. The area of the sensing unit c contacted by the conductive rod when the conductive rod is at the position 505 is smaller than the area of the sensing unit c contacted by the conductive rod when the conductive rod is at the position 503, and the conductive rod occupies an area B of the sensing unit f. In this case, as the conductive rod is moved from the position 503 to the position 505, the center of the area contacted by the conductive rod is changed from the point 513 to the point 515. At this time, an area A of the sensing unit c reduced as the conductive rod is moved from the position 503 to the position 505 is greater than the area B of the sensing unit f increased as the conductive rod is moved from the position 503 to the position 505. As a result, there is a difference between a position touched by the conductive rod and a coordinate displayed on a display. This is because the conductive rod is circular and the sensing units are quadrangular, and an area of each sensing unit is greater than an area touched by the conductive rod. Accordingly, a change in the center of the area contacted by the conductive rod from the point 513 to the point 515 in the x-axis direction is not proportional to a change in a touched position.

As described above, even when the conductive rod is linearly moved in the x-axis direction at a constant speed, a displayed coordinate is not changed proportionally. In order to minimize such a difference, a touch panel pattern obtained by connecting adjacent sensing units in adjacent columns perpendicular to the x-axis direction and adjacent sensing units in adjacent rows perpendicular to the y-axis direction as shown in FIG. 5B is provided. FIG. 5B illustrates an exemplary case where a conductive rod is moved on a touch sense panel using a capacitive overlay method.

Referring to FIG. 5B, electrodes x1a and x1b, each composed of a string of individual electrodes arranged in a direction perpendicular to the x-axis direction, are combined (e.g., by being electrically connected through one or more adjacent individual electrodes in adjacent strings) to form a common electrode including two strings of electrodes, and x2a and x2b, each composed of a string of individual electrodes arranged in a direction perpendicular to the y-axis direction, are combined (e.g., by being electrically connected through one or more adjacent individual electrodes in adjacent strings) to form a common electrode including two strings of electrodes. Also, electrodes y1a and y1b are similarly connected to form one common electrode y1 and y2a and y2b are connected to form one common electrode y2.

For example, due to the electrode x1, individual sensing units b and f are treated as being connected to each other. Also, due to the electrode y1, individual sensing units h and e are treated as being connected to each other. An example where the conductive rod is moved from a position 507 to a position 509 in FIG. 5B will now be explained.

Individual sensing units in FIG. 5B are slightly smaller than those of FIG. 5A. However, if two sensing units are connected as a pair as shown in FIG. 5B (e.g., individual sensing units b and f), the amount of sensing energy is not reduced even though smaller sensing units than those of FIG. 5A are used. For example, although sizes of the individual sensing units of FIG. 5B are 60% of sizes of the individual sensing units of FIG. 5A, since two adjacent individual sensing units (and/or two adjacent strings of sensing units) are connected as a pair and energies thereof are transmitted to one common electrode, an overall area of sensing units in FIG. 5B is greater than that in FIG. 5A. Accordingly, the amount of sensing energy obtained by sensing units in FIG. 5B is greater than that in FIG. 5A.

When the conductive rod is initially at the position 507, an area contacted by the conductive rod has a center 517. From among sensing units a through m, the sensing units b, d, f, and i sense a touch in an x-axis direction and are treated as one electrode since they are electrically connected to form electrode x1. If the conductive rod is moved to the position 509, the sensing units k and m recognize a touch due to the electrode x2, and sense a change in the x-axis direction. In this case, although a sensed area of the sensing units k and m increased as the conductive rod is moved from the position 507 to the position 509 appears to be smaller than a sensed area of the sensing units b and d reduced as the conductive rod is moved from the position 507 to the position 509, a sensed area of the sensing units f and i is slightly increased as the conductive rod is moved from the position 507 to the position 509, and thus a more accurate touch coordinate may be obtained in FIG. 5B than in FIG. 5A. Theoretically, if very small sensing units are arranged on a touch panel, a change in an area of sensing units touched is more precisely reflected as a conductive rod is moved, and as a result, a touched area is more linearly changed according to linear constant movement of a conductive rod.

Accordingly, if sensing units have small sizes and two adjacent individual sensing units are connected as a pair in an x-axis direction as shown in FIG. 5B and connected to form one common electrode, touch sensitivity may be improved, and a difference between a touch point and a displayed coordinate is reduced because of the small sizes of the sensing units.

Also, if sensing units are connected as a pair in this way, a decrease in the amount of sensing energy due to small sizes of the sensing units is prevented. That is, since two adjacent sensing units are connected as one, if the two sensing units are touched, the amount of sensing energy is accordingly increased, and thus an SNR may be higher than that of a case where two sensing units are not connected.

Also, an area occupied by a pattern in which electrode lines are extended and connected to a touch controller may be reduced.

FIGS. 5C and 5D illustrate exemplary cases where a conductive rod is moved on a touch sense panel using a capacitive overlay method.

FIG. 5C illustrates an exemplary touch screen panel manufactured by using an existing single line patterning (SLP) method, and FIG. 5D illustrates an exemplary touch screen panel manufactured by using a pair patterning (PP) method according to an embodiment of the inventive concept. For comparison purposes, sizes of unit cells of the SLP method of FIG. 5C and unit cells of the PP method of FIG. 5D are the same. Centers of unit cells of the touch screen panels in an x-axis direction of FIGS. 5C and 5D are the same. Cells having the same numbers, such as cells 11, cells 12, cells 13, cells 14, cells 15, and cells 16, are each treated as one unit cell in the 2-PP method, and the units cells of the PP method correspond to the unit cells of the SLP method. In detail, from among the unit cells of the PP method, sub-cells at a left upper side are referred to as ‘top left (TL)’, sub-cells at a left lower side are referred to as ‘bottom left (BL)’, sub-cells at a right upper side are referred to as ‘top right (TR)’, and sub-cells at a right lower side are referred to as ‘bottom right (BR)’. In the SLP method, as shown in FIG. 5C, cells 1, 4, and 7 form one electrode, cells 2, 5, and 8 form one electrode, and cells 3, 6, and 9 form one electrode. In the PP method, as shown in FIG. 5D, cells 11X (TL, BL, TR, and BR) and cells 14X form one electrode, cells 12X and cells 15X form one electrode, and cells 13X and cells 16X form one electrode.

A circle in each of FIGS. 5C and 5D denotes an effective touch area in which an electrostatic capacitance is subject to a change when touched by a finger or a stylus pen. Accordingly, in FIGS. 5C and 5D, an overlapped area between an electrode and the circle is proportional to a touch energy value of the electrode recognizable by a touch controller. Of course, when the electrode is touched, an error may be caused according to an anisotropic permittivity of a medium and a fringing effect due to a three-dimensional structure of the electrode or an edge of a touched object. However, in consideration of sizes of generally developed touch screen panels, the present embodiment using the effective touch area is appropriate.

Although various formulae and algorithms are used in order to read an electrostatic capacitance from an electrode and extract a touch coordinate, it is important in most applications to ensure that touch coordinates are extracted linearly when a touch is moved linearly and at a constant speed. This is because increased linearity of extracted coordinates increases the accuracy of a touch system, simplifies hardware, and reduces the amount of software calculation, improved linearity is an evaluation criterion for evaluating the performance of a touch system when a pattern of a touch screen panel or a coordinate extraction algorithm is developed. A method of binding patterns of a touch screen panel as a predetermined number of pairs according to the inventive concept improves linearity.

In the case of the SLP method of FIG. 5C, it is assumed that a touch, here indicated by a touch circle, occurs at a position ‘a’. At this time, since an overlapped area between the cell 5 and the touch circle and an overlapped area between the cell 6 and the touch circle are similar to each other, an x-coordinate corresponds to a point between the cell 5 and the cell 6. Next, when a touch occurs at a position ‘b’, the overlapped areas between the touch circle and the cell 5 and an area between the circle and the cell 6 are changed. Due to the touch circle at the position ‘b’, a newly covered area of the cell 5 is ‘C’ and a newly uncovered area of the cell 6 is ‘D’. However, as shown in FIG. 5C, the area ‘C’ is significantly greater than the area ‘D’. Accordingly, an x-coordinate corresponds to a point closer to a center of an electrode including the cell 5.

In order to more clearly explain such an effect, the touch is moved to a position ‘c’. A difference between an area ‘A’ and an area ‘B’ is greater than a difference between the area ‘C and the area ‘D’. Accordingly, an x-coordinate corresponds to a point closer to the center of the electrode including the cell 5.

According to the PP method of FIG. 5D, the linearity of touch coordinates is better than that according to the SLP method of FIG. 5C, which will be explained below.

In the case of the PP method of FIG. 5D, it is assumed that touched areas and movements are the same as those in the SLP method of FIG. 5C. When a position ‘d’ is touched, as indicated by a touch circle, an overlapped area between the touch circle and the cells 12BR and 15TR and an overlapped area between the circle and the cells 13BL and 16TL are similar to each other. In this case, a point between the two electrodes respectively including the cells 12BR and 15TR and the cells 13BL and 16TL may be extracted as an x-coordinate. When a position ‘e’ is touched, areas ‘I’ and ‘J’ are newly covered and areas ‘K’ and ‘L’ are newly uncovered when a touch is moved from the position ‘d’ to the position ‘e’, and an area difference is less than that of the case where the SLP method is used. Also, even when a position ‘f’ is touched, it is found from FIG. 5D that newly covered areas ‘E’ and ‘F’ are similar to newly uncovered areas ‘G’ and ‘H’. In addition, even when a touch is moved from the position ‘d’ to the position ‘e’ or from the position ‘e’ to the position T, it is found that areas newly covered and uncovered in both cells are almost similar to each other. That is, it is found that a change in the areas ‘E’ and ‘F’ and a change in the areas ‘I’ and ‘J’ are less than those of the case where the SLP method is used. As a result, the PP method in FIG. 5D more easily ensures the linearity of extracted touch coordinates than the SLP method in FIG. 5C. Also, since the PP method ensures better linearity with respect to change in area than the SLP method, the PP method has a smaller difference between a touch point and an extracted coordinate than the SLP method.

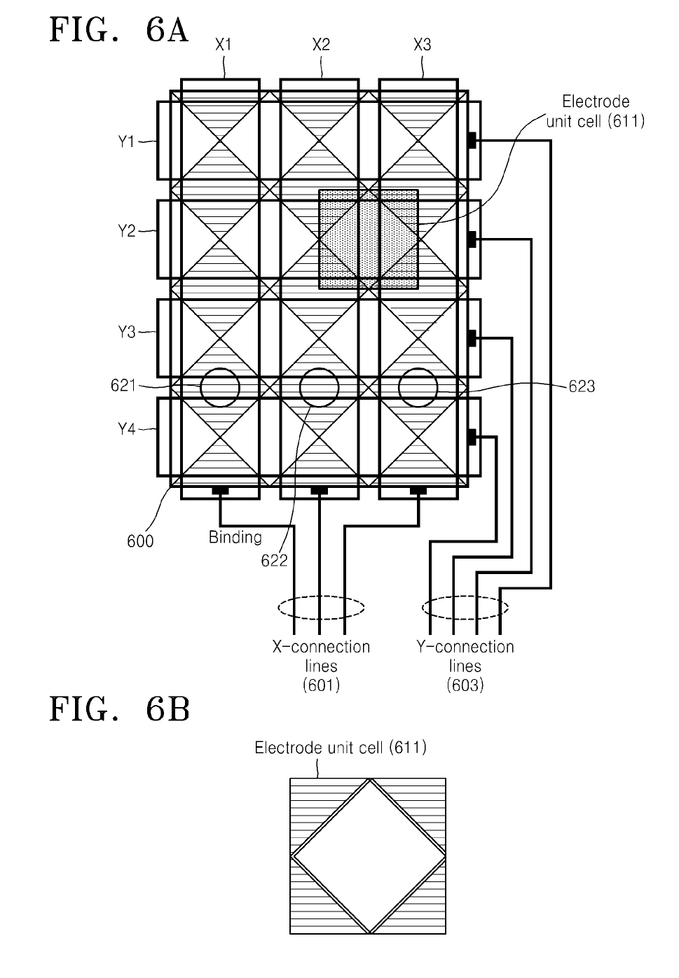

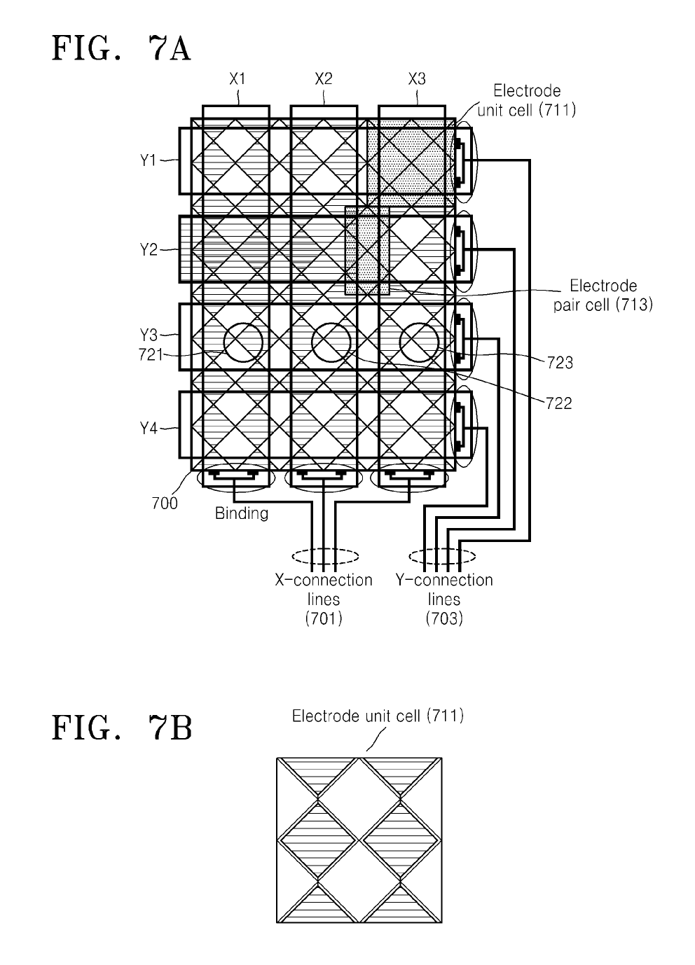

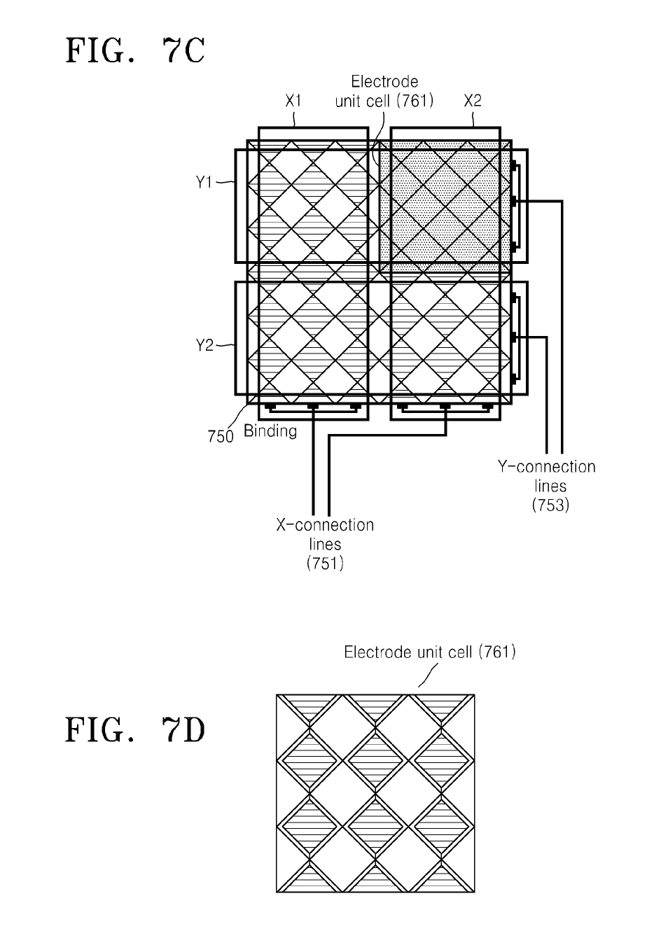

In FIG. 6A, in a general touch sense panel 600 using a capacitive overlay method, electrode lines 601 of electrodes x1, x2, and x3 may be arranged in an x-axis direction and may be connected to a touch controller (not shown), and electrode lines 603 of electrodes y1, y2, y3, and y4 may be arranged in a y-axis direction and may be connected to the touch controller. In this case, a smallest possible electrode unit cell 611 (i.e., smallest cell that includes at least one entire individual electrode) has a square shape surrounding an individual sensing unit. An area of a smallest possible electrode unit cell is equal to an area of two individual sensing units. As described above, the accuracy of a touch coordinate obtained by using sensing units as shown in FIG. 6 is lower than that of a touch coordinate obtained by using electrodes that are connected as a pair as shown in FIG. 7A.

Although accuracy is lowered when a conductive rod is larger than a sensing unit as described above, a problem is caused even when a conductive rod is smaller than a sensing unit. It is assumed that a conductive rod has a size equal to as shown at a position 621 and is moved from the position 621 to a position 622 to a position 623. When the conductive rod is contacting any of areas within sensing units at the positions 621, 622, and 623, since there is no sensing unit for sensing a touch in a y-axis direction, a position of the conductive rod in the y-axis direction may not be instantly determined. While the conductive rod is moved from the position 621 to the position 622, although the conductive rod passes through part of the electrodes y3 and y4 and thus a position of the conductive rod in the y-axis direction may be determined, when the conductive rod is moved to the position 622, since the conductive rod does not touch any sensing unit for sensing a touch in the y-axis direction, it is difficult to determine a y-coordinate. Accordingly, it is preferable that an individual sensing unit is small. If sensing units are very densely arranged, the accuracy of a touch coordinate may be improved.

FIG. 6B illustrates the electrode unit cell 611 of the touch sense panel of FIG. 6A. The area of the electrode unit cell 611 is equal to an area of two sensing units.

FIGS. 7A and 7B illustrate an exemplary case where sensing units are connected as pairs in a touch sense panel 700 using a capacitive overlay method.

A size of an individual sensing unit of FIG. 7A is smaller than that of FIG. 6A. However, two adjacent electrodes in two adjacent rows or columns are electrically connected. For example, an electrode pair cell 713 is formed in such a way that two adjacent pixels are treated as one electrode. An electrode unit cell 711 of the touch sense panel 700 is formed by binding two adjacent electrode pairs as shown in FIG. 7A. Although a sensing unit of FIG. 7A is smaller than that of FIG. 6A in the touch sense panel having the same area, since two electrodes are bound as one, an SNR of FIG. 7A is higher than that of FIG. 6. Also, since the sensing unit of FIG. 7A is smaller than that of FIG. 6A, although two electrodes are bound, the accuracy of a touch coordinate of FIG. 7A is higher than that of FIG. 6A.

In FIG. 7A, since a size of one side of a sensing unit is ½ and an area of a sensing unit is ¼ of those of a sensing unit of FIG. 6, respectively, there is no difference in configuring a connection line pattern. That is, in FIGS. 6A and 7A, the number of connection lines is 3 in the x-axis direction and is 4 in the y-axis direction. Three connection lines 701 in the x-axis direction and four connection lines 703 in the y-axis direction are shown in FIG. 7A. However, in FIG. 7A, in one embodiment, a size of one side of a sensing unit may be ⅔ instead of ½ of that of FIG. 6. While 36 sensing units are disposed in one axis direction in FIG. 6A, 54 sensing units should be disposed in FIG. 7A, and 27 connection lines are necessary for the 54 sensing units. That is, since 36 connection lines are necessary in FIG. 6A, and 27 connection lines are necessary in FIG. 7A, a connection pattern space in FIG. 7A is 75% of that in FIG. 6A.

Also, in this embodiment, arithmetically, the amount of touch energy in FIG. 7A is 1.3 times higher than that in FIG. 6. Since the sensing units themselves in FIG. 7A are smaller than those in FIG. 6, when a conductive rod having the same size as that of FIG. 6A is moved from a position 721 to a position 722 to a position 723, a problem in which electrodes in only one axis direction are used, which makes it difficult to calculate a coordinate in another axis direction, described with reference to FIG. 6, may be avoided.

FIG. 7B illustrates only an exemplary electrode unit cell in the touch panel of FIG. 7A.

FIG. 7C illustrates an exemplary case where sensing units are connected in groups of three in a touch sense panel using a capacitive overlay method according to one embodiment.

Three adjacent electrodes are connected to become X1, and three adjacent electrodes are connected to become X2. Adjacent electrodes are connected to form Y1 and Y2 in a y-axis direction in the same way. Accordingly, there are two connection lines 751 of electrodes bound in an x-axis direction and connected to a touch controller, and there are two connection lines 753 of electrodes bound in the y-axis direction and connected to the touch controller. An electrode unit cell 761 covers an area the size of 18 individual sensing units as shown in FIG. 7C. In other embodiments, four or more sensing electrodes may be connected to one connection line.

FIG. 7D illustrates only an exemplary electrode unit cell of the touch sense panel of FIG. 7C. If a size of an electrode unit cell is equal to a size of a sensing unit of FIG. 6, a length and an area of a sensing unit in the touch panel of FIG. 7c are ⅓ and 1/9 of the sensing unit of FIG. 6, respectively.

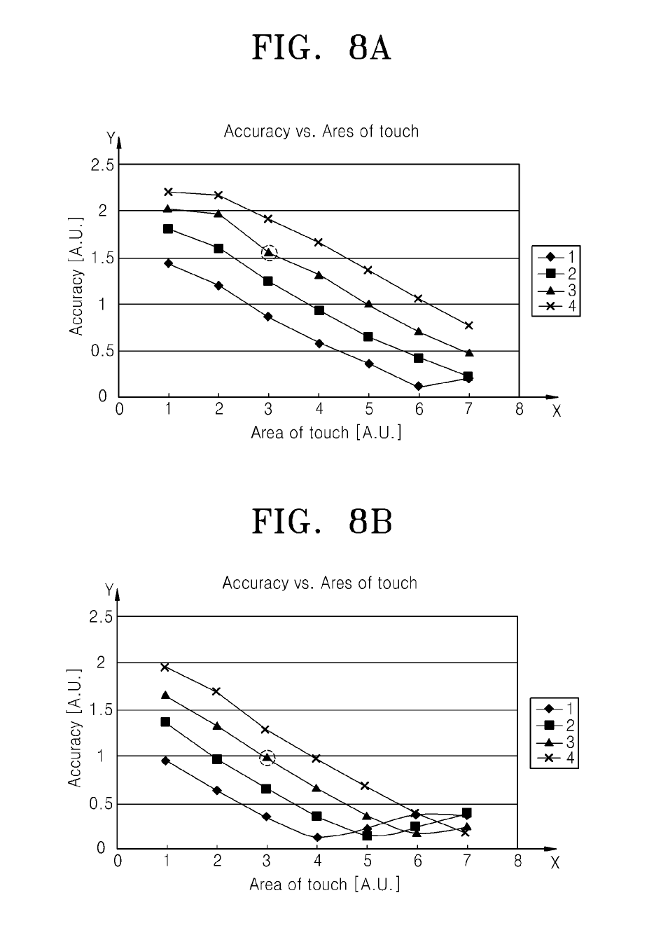

FIGS. 8A and 8B are exemplary simulation graphs showing accuracy between a touch point and a touch coordinate according to electrode patterns in touch sense panels using a capacitive overlay method.

FIG. 8A is an exemplary graph illustrating accuracy between a touch point and a touch coordinate in a method using one connection line for one electrode row or column as shown in FIG. 6. In the graph, a y-axis represents accuracy and the accuracy may be understood as a difference. Accordingly, as the graph is closer to 0 on the y-axis, a difference between a touch point and a displayed touch coordinate is reduced.

An x-axis of the graph represents a size of a conductive rod. When the area of touch is 1, a touched area of a touched terminal is smallest, and when the area of touch is 7, a touched area of a touched terminal is largest. In general, as a touched area of a touched terminal is increased, more sensing units sense the touch and thus a difference is decreased, which increases accuracy.

Four curves are illustrated in total. The curves correspond to different pitches of electrode unit cells (e.g., pitches between 1 and 4, with 1 being smaller). Since a pitch in FIG. 6A is a distance from a center of a reference sensing unit to a center of an adjacent sensing unit, the pitch is equal to a length of the reference sensing unit. Here, the pitches 1 through 4 are not accurate values but relative values. As a pitch of a sensing unit is decreased, that is, a size of a sensing unit is decreased, accuracy is naturally increased.

FIG. 8B is an exemplary simulation graph illustrating an accuracy when two electrodes are electrically connected and a touch is sensed by using one connection line for at least two rows or columns, according to one embodiment.

A y-axis and an x-axis are the same as those in FIG. 8A. However, an electrode unit cell of FIG. 8B is slightly different from that of FIG. 8A. The electrode unit cell is formed like the electrode unit cell 711 of FIG. 7A, and pitches of electrode unit cells of FIG. 8B are equal to the pitches 1, 2, 3, and 4 of the electrode unit cells of FIG. 8A.

Accuracy in FIG. 8B is better than accuracy in FIG. 8A. That is, a difference in FIG. 8B is lower than a difference in FIG. 8A. For example, if a size of a conductive rod is 2, accuracy is about 1.6 when a pitch of an electrode unit cell is 2 in FIG. 8A, and is slightly lower than 1 in FIG. 8B. An accuracy is actually a difference as described above, it is found that FIG. 8B provides better performance. A touch sensing standard requires that accuracy be equal to or less than a predetermined level when a conductive rod has a predetermined size. For example, a standard requires that accuracy be equal to or less than 1 when a size of a conductive rod is 4. In this case, in the graph of FIG. 8A, only electrode unit cells in which the pitches are 1 and 2 area appropriate, whereas in the graph of FIG. 8B, electrode unit cells in which the pitches are all of 1, 2, 3, and 4 are appropriate.

Analysis in the y-axis will be made. If a standard requires that accuracy be equal to or less than 1, when an electrode unit cell has a pitch 2, a size of a conductive rod should be greater than 3.8. Under the same condition, in FIG. 8B, if a standard requires that accuracy is equal to or less than 1, when an electrode unit cell has a pitch 2, a size of a conductive rod should be about 2.

As a result, when examining a case where the pitch is 3 and the area of touch is 3, it is found that accuracy in FIG. 8B is 60% better than that of FIG. 8A. Also, although a PP method has a larger pitch between patterns than an SLP method (see FIG. 8A), the PP method provides better accuracy even when the area of touch is small.

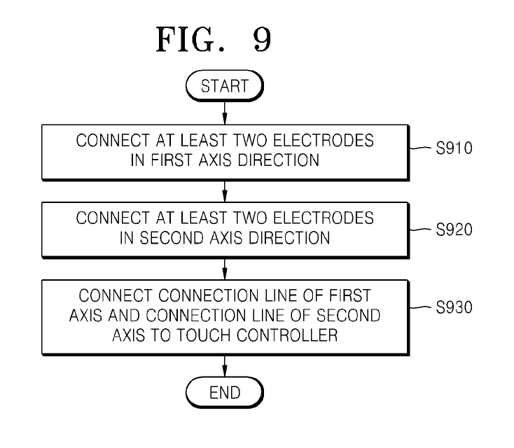

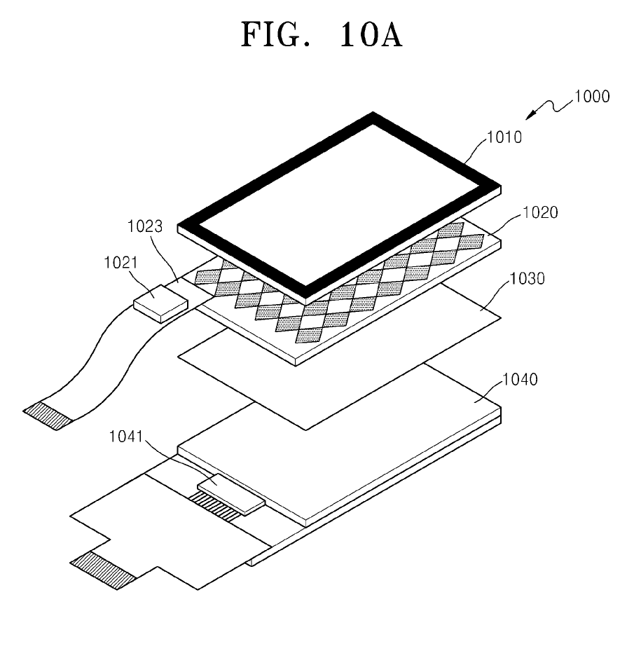

FIG. 9 is an exemplary flowchart illustrating a method of forming a touch panel on which two or more electrodes are connected, according to one embodiment

In operation S910, at least two electrodes in a first axis direction are connected to be treated as one electrode. The first axis direction may be an x-axis direction or a y-axis direction. If the first axis direction is the x-axis direction, a second axis direction, which will be explained later, may be a y-axis direction. Since at least two electrodes are connected as one electrode, two electrodes may be connected as one electrode or three or more electrodes may be connected as one electrode. A plurality of electrodes connected as one electrode in this way may be adjacent electrodes. In addition, because each of the two electrodes may be individual electrodes connected as part of a string of individual electrodes electrically connected in a direction perpendicular to the first axis direction, the two strings of individual electrodes may form a single common electrode.

In operation S920, at least two electrodes are connected in the second axis direction to be treated as one electrode. Likewise, since at least two electrodes are connected as one electrode, two electrodes may be connected as one electrode or three or more electrodes may be connected as one electrode. A plurality of electrodes connected as one electrode in this way may be adjacent electrodes. In addition, because each of the two electrodes may be individual electrodes connected as part of a string of individual electrodes electrically connected in a direction perpendicular to the second axis direction, the two strings of individual electrodes may form a single common electrode.

In operation S930, connection lines in the first axis direction and the second axis direction to which a plurality of electrodes are connected as one electrode are connected to a touch controller. Due to such a pattern connection of a touch sense panel, the touch sense panel according to the inventive concept may have low noise and have high touch sensitivity.

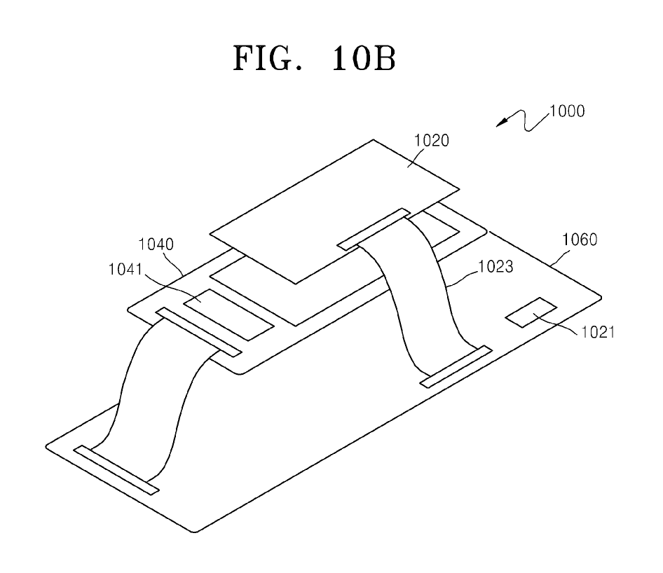

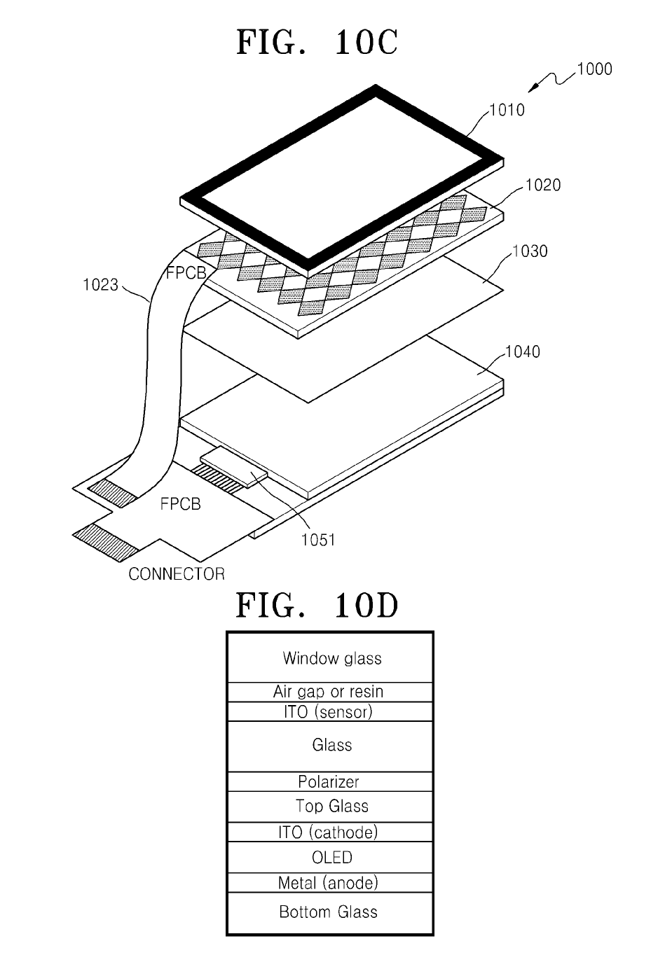

FIGS. 10A, 10B, 10C, and 10D illustrate exemplary structures of a printed circuit board (PCB) of a display device 1000 on which a touch panel is mounted, according to certain embodiments. FIGS. 10A, 10B, 10C, and 10D each illustrate the display device 1000 having a structure in which a touch panel and a display panel are separated from each other.

Referring to FIG. 10A, the display device 1000 may include a window glass 1010, a touch panel 1020, and a display panel 1040. A polarization plate 1030 for optical characteristics may be further disposed between the touch panel 1020 and the display panel 1040.

The window glass 1010 is generally formed of a material such as acryl or tempered glass, and protects a module from scratches due to an external impact or repeated touch. The touch panel 1020 is formed by patterning an electrode by using a transparent electrode formed of, for example, indium tin oxide (ITO), on a glass substrate or a polyethylene terephthlate (PET) film. A touch controller 1021 may be mounted in the form of a chip-on-board (COB) on a flexible printed circuit board (FPCB). The touch controller 2021 detects a change in capacitance from each electrode, extracts a touch coordinate, and provides the extracted touch coordinate to a host controller. The display panel 1040 may be generally formed by combining two sheets of glasses consisting of an upper plate and a lower plate. Also, a display driving circuit 1041 may be attached in the form of a chip-on-glass (COG) to a mobile display panel. An area of a connection pattern 1023 from the touch panel 1020 to the touch controller 1021 may be reduced when two or more electrode lines are bound as one, and thus a dead zone of the display panel 1040 or the window glass 1010 may be reduced.

FIG. 10B illustrates an exemplary structure of a PCB of a display device according to another embodiment. Referring to FIG. 10B, the touch controller 1021 may be disposed on a main board 1060, and a voltage signal from a sensing unit may be transmitted and received between the touch panel 1020 and the touch controller 1021 via the connection pattern 1023 by means of the FPCB. Meanwhile, the display driving circuit 1041 may be attached to the display panel 1040 in the form of a COG as shown in FIG. 10A. The display driving circuit 1041 may be connected to the main board 1060 by means of the FPCB. That is, the touch controller 1021 and the display driving circuit 1041 may transmit and receive various information and signals via the main board 1060. As described above, even in FIG. 10B, when two or more adjacent electrodes are electrically connected to constitute the connection pattern 1023, an area occupied by the connection pattern 1023 is reduced.

FIG. 10C illustrates a structure of the display device 1000 in which a touch controller unit and a display driving unit are integrated in one semiconductor chip. Referring to FIG. 10C, the display device 1000 may include the window glass 1010, the touch panel 1020, the polarization plate 1030, and the display panel 1040. In particular, a semiconductor chip 1051 may be attached to the display panel 1040 in the form of chip of a COG. The touch panel 1020 and the semiconductor chip 1051 may be electrically connected to each other through the connection pattern 1023.

FIG. 10D illustrates a structure of a panel of the display device 1000 of FIGS. 10A, 10B, and 10C. FIG. 10D illustrates an OLED as an example of the display device 1000. Referring to FIG. 10D, a sensing unit may be formed by patterning a transparent electrode (ITO sensor), and may be formed on a glass substrate separated from the display panel 1040. The glass substrate on which the sensing unit is formed may be separated from the window glass 1010 by a predetermined air gap or resin. The glass substrate may be separated from the upper and lower glass plates constituting the display panel 1040 by a predetermined polarization plate. The additional layers may be arranged as shown in the remaining portions of FIG. 10D.

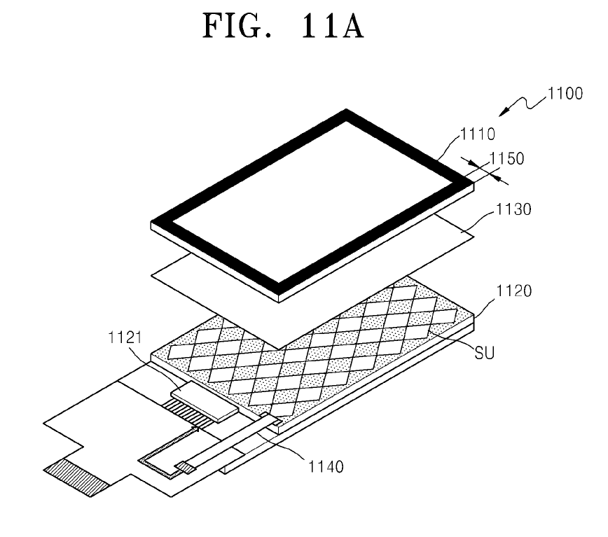

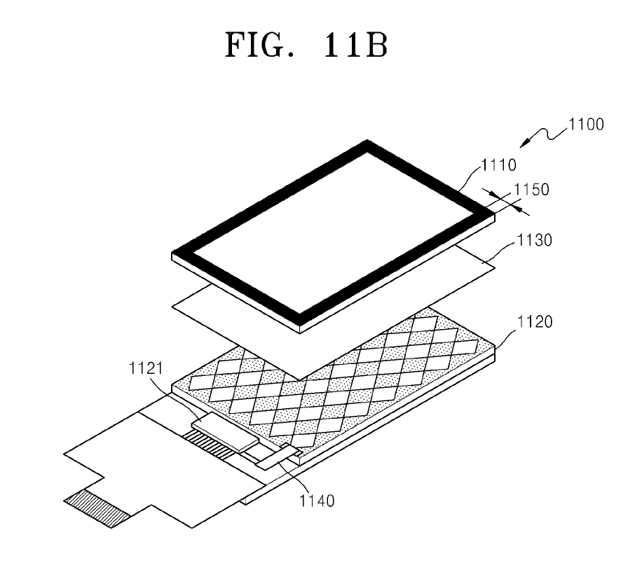

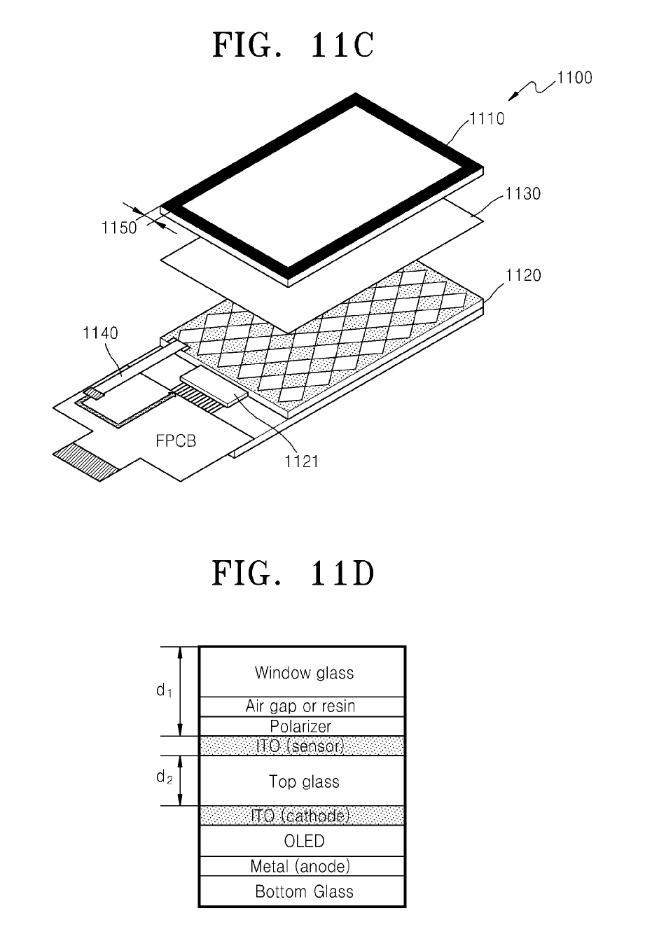

FIGS. 11A and 11B illustrate exemplary structures of a PCB when the touch panel 1020 and the display panel 1040 are incorporated. That is, a touch panel may be overlaid on a display panel either in a separated manner, as described in connection with FIGS. 10A-10D, or in an integrated manner.

Referring to FIG. 11A, a display device 1100 may include a window glass 1110, a display panel 1120, and a polarization plate 1130. In particular, when a touch panel is formed, the touch panel may not be formed on a separate glass substrate, but may be formed by patterning a transparent electrode on an upper plate of the display panel 1120. FIG. 11A illustrates an example where a plurality of sensing units SU are formed on the upper plate of the display panel 1120. Also, when the panel structure having the above structure is formed, one semiconductor chip 1121 in which a touch controller and a display driving circuit are incorporated may be employed. A connection pattern 1140 connected to a touch controller may be simplified by binding a plurality of electrodes according to the inventive concept. Accordingly, a dead zone 1150 in the window glass 1110 may be reduced.

FIG. 11B illustrates a structure similar to that of the display device 1100 of FIG. 11A. FIG. 11B illustrates an example where a voltage signal from a sensing unit is not provided to the semiconductor chip 1120 through an FPCB, but is directly provided to the semiconductor chip 1121 through a conductive line. As described above, the connection pattern 1140 connected to the touch controller in FIG. 11B may be simplified by binding a plurality of electrodes as one according to the inventive concept. Accordingly, the dead zone 1150 in the window glass 1110 may be reduced.

FIG. 11C illustrates another alternative layout for the elements shown in FIG. 11A, and FIG. 11D illustrates an exemplary structure of a panel of the display device 1100 of FIGS. 11A, 11B, and 11C.

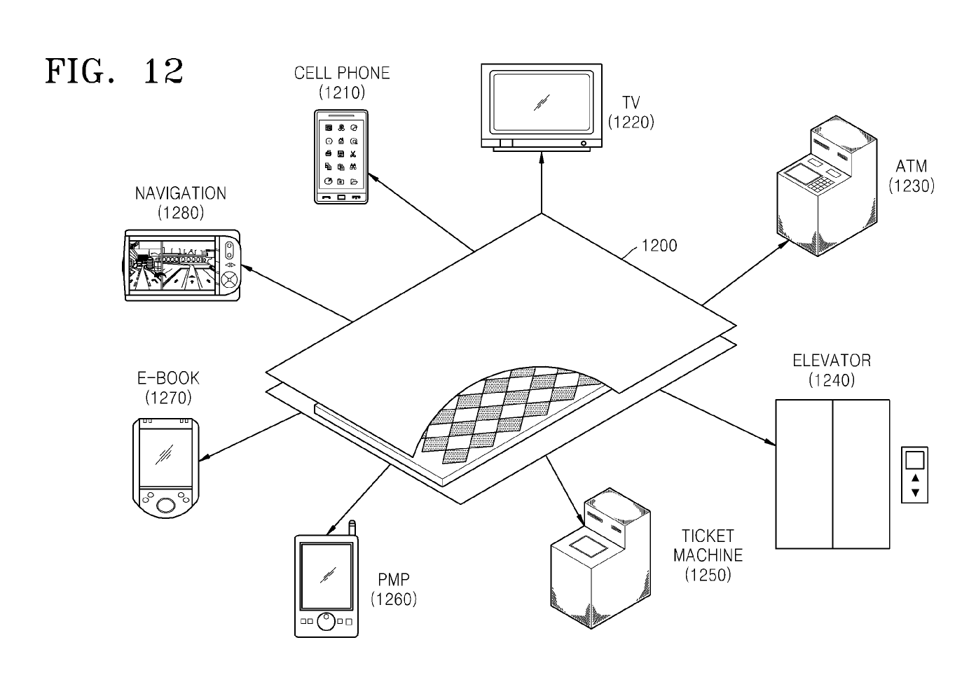

FIG. 12 illustrates various exemplary products in which a touch system 1200 according to certain embodiments is installed.

Currently, products including a touch screen are widely used in various fields, and are rapidly replacing button-based devices due to their superior spatial characteristics. The most explosive demand is in the field of mobile phones. In particular, since convenience and the size of a terminal are very important in mobile phones, touch phones that do not include unnecessary keys or minimize the number of keys have recently come into the spotlight. Accordingly, the touch system 1200 may be used, for example, in a cell phone 1210, a television (TV) 1220 including a touch screen, an automatic teller machine (ATM) 1230, which allows for cash withdrawal and remittance, an elevator 1240, a ticket machine 1250 used in a subway and the like, a portable multimedia player (PMP) 1260, an e-book 1270, a navigation device 1280, and so on. In addition, a touch display device is rapidly replacing a general button-based interface in all fields requiring a user interface.

While the inventive concept has been particularly shown and described with reference to exemplary embodiments thereof using specific terms, the embodiments and terms have been used to explain the inventive concept and should not be construed as limiting the scope of the inventive concept defined by the claims. The preferred embodiments should be considered in a descriptive sense only and not for purposes of limitation. Therefore, the scope of the inventive concept is defined not by the detailed description of the inventive concept but by the appended claims, and all differences within the scope will be construed as being included in the inventive concept.

What is claimed is:

1. A touch sense panel, comprising:
a first set of individual sensing units for sensing a location along a first axis;
the first set of individual sensing units including a first plurality of strings of individual sensing units, each string including at least two of the individual sensing units of the first set, the at least two individual sensing units electrically connected to each other and arranged in a direction perpendicular to the first axis;
wherein a first individual sensing unit of a first string of the first plurality of strings is electrically connected to a first individual sensing unit of a second string of the first plurality of strings, the second string adjacent to the first string, such that the first string and the second string form a single, first electrode.

2. The touch sense panel of claim 1, wherein:
the first sensing unit of the first string and the first sensing unit of the second string are arranged adjacent to each other in a direction parallel to the first axis.

3. The touch sense panel of claim 1, wherein:
a second sensing unit of the first string is electrically connected to a second sensing unit of the second string.

4. The touch sense panel of claim 1, wherein:
the first electrode is connected to a touch controller through a connection line.

5. The touch sense panel of claim 1, wherein:
the first set of individual sensing units includes individual first electrodes having a diamond shape, such that at least one corner of each individual first electrode is adjacent a corner of another one of the individual first electrodes.

6. The touch sense panel of claim 1, further comprising:
a second set of individual sensing units for sensing a location along a second axis, the second set of individual sensing units interleaved with the first set of individual sensing units.

7. The touch sense panel of claim 6, wherein:
the second set of individual sensing units include a plurality of second strings of individual sensing units, each string including at least two of the individual sensing units of the second set, the at least two individual sensing units electrically connected to each other and arranged in a direction perpendicular to the second axis;
wherein a first individual sensing unit of a first string of the plurality of second strings is electrically connected to a first individual sensing unit of a second string of the plurality of second strings, the second string adjacent to the first string, such that the first string and the second string form a single, second electrode.

8. The touch sense panel of claim 7, wherein:
the first electrode is connected to a touch controller through a first connection line; and
the second electrode is connected to the touch controller through a second connection line.

9. The touch sense panel of claim 7, wherein:
the first axis is perpendicular to the second axis.

10. The touch sense panel of claim 7, wherein:
the first set of individual sensing units includes individual first electrodes having a diamond shape, such that at least one corner of each individual first electrode is adjacent a corner of another one of the individual first electrodes;
the second set of individual sensing units includes individual second electrodes having a diamond shape, such that at least one corner of each individual second electrode is adjacent a corner of another one of the individual second electrodes; and
at least one side of each individual first electrode is adjacent a side of an individual second electrode.

11. The touch sense panel of claim 1, wherein:
the touch sense panel is connected to a controller and is overlaid on a display panel.

12. A touch sense panel, comprising:
a first set of individual sensing units for sensing a location along a first axis, the first set of individual sensing units comprising:
a first electrode including at least two of the individual sensing units of the first set arranged in a direction perpendicular to the first axis; and
a second electrode including at least two other of the individual sensing units of the first set arranged in a direction perpendicular to the first axis,
wherein the first electrode and the second electrode are electrically connected to each other to form a first common electrode.

13. The touch sense panel of claim 12, further comprising:
a second set of individual sensing units for sensing a location along a second axis, the second set of individual sensing units interleaved with the first set, and comprising:
a third electrode including at least two of the individual sensing units of the second set arranged in a direction perpendicular to the second axis; and
a fourth electrode including at least two other of the individual sensing units of the second set arranged in a direction perpendicular to the second axis,
wherein the third electrode and the fourth electrode are electrically connected to each other to form a second common electrode.

14. The touch sense panel of claim 13, wherein:
the first axis is perpendicular to the second axis.

15. The touch sense panel of claim 13, wherein:
the first common electrode is connected to a touch controller through a first connection line; and
the second common electrode is connected to the touch controller through a second connection line.

16. The touch sense panel of claim 13, wherein
the first set of individual sensing units includes individual first electrodes having a diamond shape, such that at least one corner of each individual first electrode is adjacent a corner of another one of the individual first electrodes;
the second set of individual sensing units includes individual second electrodes having a diamond shape, such that at least one corner of each individual second electrode is adjacent a corner of another one of the individual second electrodes; and
at least one side of each individual first electrode is adjacent a side of an individual second electrode.

17. The touch sense panel of claim 12, wherein:
the touch sense panel is connected to a controller and is overlaid on a display panel.

18. The touch sense panel of claim 17, wherein:
the touch sense panel is part of a cell phone, PDA, a television, a portable multimedia player, an e-book, or a navigation device.

19. A device including a touch sense panel, comprising:
a touch sense panel including a plurality of rows and columns, each row including a string of individual electrodes, and each column including a string of individual electrodes, wherein each row is electrically connected to at least one other row to form a common electrode, and each column is electrically connected to at least one other column to form a common electrode;
a plurality of connection lines, wherein each connection line is connected to a respective common electrode, so that the number of common electrodes is at least two times the number of lines in the plurality of connection lines.

20. The device of claim 19, further comprising:
a display panel over which the touch sense panel is overlaid.
